(19) United States
(12) Patent Application Publication
(10) Pub. No.: US 2008/0044588 A1
(43) Pub. Date: Feb. 21, 2008

(54) Method for Treating a Hydrophilic Surface

(76) Inventor: Vinay G. Sakhrani, Raleigh, NC (US)

Correspondence Address: COATS & BENNETT, PLLC, 1400 Crescent Green, Suite 300, Cary, NC, 27518, US

(21) Appl. No.: 11/464,819

(22) Filed: Aug. 15, 2006

(51) Int. Cl. C08J 7/18

(52) U.S. Cl. 427/490

(57) ABSTRACT

A method for increasing the hydrophobic characteristics of a surface. The surface is exposed to an ionizing gas plasma at about atmospheric pressure for a predetermined period of time. The ionizing gas plasma is formed from a mixture of a carrier gas and a reactive gas. The reactive gas may be comprised of one or more hydrocarbon compound such as an alkane, an alkene, and an alkyne. Alternatively, the reactive gas may be a fluorocarbon compound.

### CROSS-REFERENCE TO RELATED APPLICATIONS

The present application is related to co-pending U.S. patent application Ser. No. 10/791/542 filed on Mar. 2, 2004, entitled “Article with Lubricated Surface and Method,” which is incorporated herein by reference it its entirety.

### BACKGROUND

It is well known in the art that friction is the resistant force that prevents two objects from sliding freely when in contact with one another. There are a number of different types of frictional forces depending upon the particular motion being observed. Static friction is the force that holds back a stationary object up to the point where the object begins to move. Kinetic friction is the resistive force between two objects in motion that are in contact with one another. For any two objects in contact with one another, a value known as the coefficient of friction can be determined which is a relative measure of these frictional forces. Thus, there is a static coefficient of friction and a kinetic coefficient of friction. Stated another way, the coefficient of friction relates to the amount of force necessary to initiate movement between two surfaces in contact with one another, or to maintain this sliding movement once initiated. Because of their chemical composition, physical properties, and surface roughness, various objects have different coefficients of friction. Softer, more compliant materials such as rubber and elastomers tend to have higher coefficient of friction values (more resistance to sliding) than less compliant materials. The lower the coefficient of friction value, the lower the resistive force or the slicker the surfaces. For example, a block of ice on a polished steel surface would have a low coefficient of friction, while a brick on a wood surface would have a much higher coefficient of friction.

The difference between the static and kinetic coefficients of friction is known as “stick-slip.” The stick-slip value is very important for systems that undergo back-and-forth, stop-and-go, or very slow movement. In such systems, a force is typically applied to one of the two objects that are in contact. This force must be gradually increased until the object begins to move. At the point of initial motion, referred to as “break-out,” the static friction has been overcome and kinetic frictional forces become dominant. If the static coefficient of friction is much larger than the kinetic coefficient of friction, then there can be a sudden and rapid movement of the object. This rapid movement may be undesirable. Additionally, for slow moving systems, the objects may stick again after the initial movement, followed by another sudden break-out. This repetitive cycle of sticking and break-out is referred to as “stiction.”

In order to minimize the friction between two surfaces, a lubricant can be applied which reduces the force required to initiate and maintain sliding movement. However, when two lubricated surfaces remain in contact for prolonged periods of time, the lubricant has a tendency to migrate out from the area of contact due to the squeezing force between the two surfaces. This effect tends to increase as the squeezing force increases. As more of the lubricant migrates from between the two surfaces, the force required to initiate movement between the surfaces can revert to that of the non-lubricated surfaces, and stiction can occur. This phenomenon can also occur in slow moving systems. Because of the slow speed, the time interval is sufficient to cause the lubricant to migrate away from the area of contact. Once the object moves past the lubricant-depleted area, the object comes into contact with a lubricant-rich area. The frictional force is less in the lubricant-rich area and sudden, rapid movement of the object can occur.

Attempts have been made to reduce the migration of lubricant from between surfaces in contact with one another. In particular, methods exist using an energy source to treat a lubricant applied to one or more of the surfaces such that the migration is reduced.

Information relevant to attempts to address the above problems using a gas plasma as the energy source for several specific embodiments can be found in the following U.S. Pat. No. 4,536,179; No. 4,767,414; No. 4,822,632; No. 4,842,889; No. 4,844,986; No. 4,876,113; No. 4,960,609; No. 5,338,312; and No. 5,591,481. However, each one of these references suffers from the disadvantage of treating the lubricant layer with an ionizing gas plasma generated under vacuum, rendering the methods impractical for large-scale production operations.

A need exists, therefore, for a method to produce a lubricated surface in which the migration of lubricant from the area of contact between two surfaces is reduced such that the break-out force and sliding frictional force are minimized, such method not being conducted under vacuum. A need also exists for articles produced by such a method.

### SUMMARY

The inventor of the present invention is a co-inventor of co-pending U.S. patent application Ser. No. 10/791,542, entitled “Article with Lubricated Surface and Method” which is hereby incorporated by reference in its entirety. The co-pending application is directed to a method and articles that satisfy these needs. In particular, the invention of the pending application has proved useful for lubricating medical syringes. Medical syringes are typically used in two general ways. In the first, the syringe is filled with liquid then the liquid is dispensed almost immediately. In the second, the syringe is filled with liquid then stored for a length of time. While the invention of the co-pending application can be used in either case, it has been discovered that a new and novel method can be used in conjunction with the invention of the co-pending application to further enhance the stability of the lubricant layer on hydrophilic surfaces such as glass. In particular, the present invention is useful when the liquid is stored in the syringe. One aspect of the present invention comprises a method to pretreat the surface with an atmospheric plasma generated from a process gas comprising one or more carrier gases and an alkene. Another aspect of the invention comprises a method to treat the hydrophilic surface with an ionizing gas plasma at about atmospheric pressure generated from a process gas comprising one or more carrier gases and one or more reactive gases. The carrier gas is comprised of one or more inert gases, and the reactive gas is comprised of one or more hydrocarbon and fluorocarbon compounds. The reactive hydrocarbon gases are selected from alkanes, alkenes, and alkynes. The reactive fluorocarbon gases are similar to the hydrocarbon gases with one or more of the hydrogen atoms substituted with fluorine atoms.

### DEFINITIONS

In the description that follows, a number of terms are used. In order to provide a clear and consistent understanding of the specification and appended claims, including the scope to be given such terms, the following definitions are provided:

About Atmospheric Pressure. An embodiment of the invention involves the generation of an ionizing gas plasma. While gas plasmas can be produced under various levels of vacuum, the invention uses a plasma generated at essentially atmospheric pressure. While no conditions of vacuum or above-atmospheric pressure are deliberately produced by carrying out the method of the invention, the characteristics of the gas flow may create a deviation from atmospheric pressure. For example, when using a method of the invention to treat the inside of a cylindrical object, the gas flowing into the cylinder may result in a higher pressure within the cylinder than outside the cylinder.

Break-Out. An embodiment of the invention involves surfaces in sliding contact with one another. When the surfaces are in contact but at rest, a force must be applied to one of the surfaces to initiate movement. This applied force must be increased until the frictional forces opposing movement are overcome. The point at which the applied force just surpasses the frictional force and movement is initiated is known as break-out.

Chatter. Repetitive stick-slip movement associated with the movement of surfaces in contact with one another is known as chatter. When a lubricant is present between the surfaces, chatter can occur when the lubricant is squeezed out from between the surfaces, resulting in an increase in the coefficient of friction. A larger force must then be applied to the surfaces in order to initiate movement, which can cause a sudden, exaggerated movement. Chatter occurs when this cycle is repetitive.

Coefficient of Friction. The coefficient of friction relates to the amount of force necessary to initiate movement between two surfaces in contact with one another, or to maintain this sliding movement once initiated. Numerically, the term is defined as the ratio of the resistive force of friction divided by the normal or perpendicular force pushing the objects together.

Electron Beam Radiation. Electron beam radiation is a form of ionizing radiation produced by first generating electrons by means of an electron gun assembly, accelerating the electrons, and focusing the electrons into a beam. The beam may be either pulsed or continuous.

Friction. Friction is a resistive force that prevents two objects from sliding freely against each other.

Functionalized Perfluoropolyether. A perfluoropolyether which contains one or more reactive functional groups.

Gamma Radiation. Gamma radiation is a type of electromagnetic waveform, often emitted at the same time the unstable nucleus of certain atoms emits either an alpha or beta particle when the nucleus decays. Gamma radiation, being an electromagnetic waveform, is similar to visible light and x-rays but of a higher energy level which allows it to penetrate deep into materials.

Gas Plasma. When sufficient energy is imparted to a gas, electrons can be stripped from the atoms of the gas, creating ions. Plasma contains free-moving electrons and ions, as well as a spectrum of electrons and photons.

Ionizing. Ionizing means that enough energy is present to break chemical bonds.

Lubricant-Solvent Solution (coating solution). The lubricant may be diluted with an appropriate solvent prior to applying the lubricant onto the surface. The resulting mixture of lubricant and solvent is known as a lubricant-solvent solution.

Parking. Syringes used in medical applications are often pre-filled prior to use and stored. The amount of time between filling the syringe and discharging the syringe is known as parking time. In general, parking increases the break-out force.

Perfluoropolyether. A perfluoropolyether is a compound with the general chemical structure of:

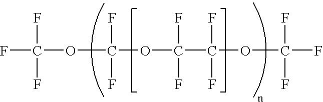

Stick-Slip. The difference between static and kinetic coefficients of friction is known as stick-slip. In systems where a lubricant is present, high mating forces can squeeze the lubricant out from between the surfaces in contact with one another. An increased force is then required to initiate sliding movement of the surfaces. This movement may occur suddenly, caused by the surfaces coming into contact with a lubricant-rich area. If the lubricant is again forced out from between the surfaces, they can begin to bind. The sliding motion can stop until the force is increased enough to once again initiate movement. This alternating sticking and slipping is called stick-slip.

Stiction. The overall phenomenon of stick-slip is known as stiction.

### DESCRIPTION

It is understood that the embodiments described herein are intended to serve as illustrative examples of certain embodiments of the present invention. Other arrangements, variations, and modifications of the described embodiments of the invention may be made by those skilled in the art. No unnecessary limitations are to be understood from this disclosure, and any such arrangements, variations, and modifications may be made without departing from the spirit of the invention and scope of the appended claims. Stated ranges include the end points of the range and all intermediate points within the end points.

A method has been described in co-pending U.S. patent application Ser. No. 10/791,542 for reducing the migration of lubricant from between surfaces in contact with one another, which comprises applying a lubricant to one or more of the surfaces, then treating the lubricant-coated surface by exposing it to an energy source. Another method described in the co-pending application comprises exposing the surface to an energy source, specifically an ionizing gas plasma at about atmospheric pressure, prior to the application of the lubricant. It is theorized that exposing the surface to the ionizing gas plasma at about atmospheric pressure prior to applying the lubricant creates active sites on the surface that facilitate the reduced migration of the lubricant. As a result of these methods, the lubricant resists migrating from between the surfaces in contact with one another, thereby reducing the break-out force and sliding frictional force. Optionally, any of the methods of the co-pending application can be applied to only one surface of an object.

Further experimentation has shown that, on hydrophilic surfaces such as glass, a thin layer of water forms on the surface after the surface is exposed to an energy source and prior to application of the lubricant. Indeed, a layer of water is always present on the glass surface under ambient conditions. Subsequent application of the lubricant over the water layer can lead to increased migration of the lubricant between surfaces in contact with one another. It is theorized that the water layer lessens the retention of the lubricant layer on the surface as achieved by the methods of the co-pending application. Water, which is always present in the air surrounding the surface, condenses on the surface almost immediately after exposure to the energy source unless the surface is maintained at a temperature of about 130° C. Maintaining such temperatures are impractical in a large-scale production environment.

The experimentation has also shown that when a medical syringe made of glass is filled with a liquid and parked for a length of time, the liquid has a tendency to migrate under the lubricant layer and lessen the bond strength of the lubricant to the glass surface. This phenomenon is the result of the hydrophilic nature of the glass surface. The liquid in the syringe has a tendency to wet the glass surface because of the surface's hydrophilic nature. The present invention serves to modify the surface characteristics of the glass to make it hydrophobic. As such, the affinity between the glass surface and the liquid stored in the syringe is reduced and the liquid no longer tends to wet the glass surface. This minimizes the migration of the liquid under the lubricant layer and allows the invention of the co-pending application to work as well with filled and parked syringes as those that are used immediately after filling.

In one embodiment of the present invention, the energy source is an ionizing gas plasma comprised of one or more carrier gases and one or more reactive gas. The carrier gas may be a noble gas including, for example, helium, neon, argon, krypton, and xenon. Alternatively, the carrier gas may be an oxidiative gas including, for example, air, oxygen, carbon dioxide, carbon monoxide, and water vapor. In yet another alternative, the carrier gas may be a non-oxidative gas including, for example, nitrogen and hydrogen. Mixtures of any of these carrier gases may also be used.

The reactive gas may be any hydrocarbon gas, such as an alkane represented by the chemical formula CₙH₂ₙ₊₂, an alkene represented by the chemical formula CₙH₂ₙ, and an alkyne represented by the chemical formula CₙH₂ₙ₋₂. Examples of alkanes are methane, ethane, propane, butane, and the like. Examples of alkenes are ethylene, propylene, isobutylene, and the like. Examples of alkynes are ethyne (acetylene), propyne, 1-butyne, and the like. Additionally, the reactive gas may be fluorocarbon compound, wherein one or more of the hydrogen atoms in the above listed hydrocarbon compounds are replaced with a fluorine atom. Examples of these fluorochemical compounds are tetrafluoromethane, tetrafluoroethylene, and hexafluoropropylene. Mixtures of any of these reactive gases may also be used.

The method of the present invention comprises exposing the hydrophilic surface to an ionizing gas plasma at about atmospheric pressure. The ionizing gas plasma is generated using a mixture of at least one carrier gas and at least one reactive gas. The reactive gas concentration may range from about 0.001 percent to about 10 percent. The time the surface is exposed to the ionizing gas plasma may range from about 0.1 second to about 5 minutes. The ionizing gas plasma deposits a layer of material directly onto the hydrophilic surface, creating a barrier between the surface and the water in the air, as opposed to creating active bonding sites as in the method of the co-pending application. Thus, the surface is now hydrophobic and nearly no water layer forms on the surface. The cross-linked lubricant layer formed by the method of the co-pending application can bond to the barrier layer without interference from a water layer. Additionally, liquid is prevented from migrating under the cross-linked lubricant layer because the liquid no longer has a tendency to wet the glass surface due to the surface's now hydrophobic nature.

The exact parameters under which the ionizing gas plasma are generated are not critical to the methods of the invention. These parameters are selected based on factors including, for example, the gas in which the plasma is to be generated, the electrode geometry, frequency of the power source, and the dimensions of the surface to be treated.

The lubricant of the co-pending application can be applied to the surface of the object by any of the numerous methods know in the art. By way of example, suitable application methods include spraying, atomizing, spin casting, painting, dipping, wiping, tumbling, and ultrasonics. The method used to apply the lubricant is not essential to the performance of the invention.

The lubricant may be a fluorochemical compound or a polysiloxane-based compound. In one embodiment of the present invention, the fluorochemical compound is a perfluoropolyether (PFPE). Representative examples of commercially available PFPE include, for example, Fomblin M®, Fomblin Y®, and Fomblin Z® families of lubricants from Solvay Solexis; Krytox® from E.I. du Pont de Nemours and Company; and Demnum™ from Daikin Industries, Limited. Table 1 presents the chemical structures of these compounds, and Table 2 presents the molecular weights and viscosities. In another embodiment of the invention of the co-pending application, the lubricant is a functionalized PFPE. Representative examples of commercially available functionalized PFPE include, for example, Fomblin ZDOL®, Fomblin ZDOL TXS®, Fomblin ZDIAC®, Fluorolink A10®, Fluorolink C®, Fluorolink D®, Fluorolink E®, Fluorolink E10®, Fluorolink F10®, Fluorolink L®, Fluorolink L10®, Fluorolink S10®, Fluorolink T®, and Fluorolink T10®, from Solvay Solexis as shown in Table 3. In yet another embodiment of the invention of the co-pending application, the functionalized PFPE may be an emulsion. Representative example of commercially available functionalized PFPE emulsions are, for example, Fomblin FE-20C® and Fomblin FE-20AG® from Solvay Solexis. In yet another embodiment of the invention of the co-pending application, the fluorochemical compound is a chlorotrifluoroethylene. A representative example of commercially available chlorotrifluoroethylene is, for example, Daifloil™ from Daikin Industries, Limited (see Table 2). In still another embodiment of the invention of the co-pending application, the polysiloxane-based compound is a silicone oil with a dimethlypolysiloxane chemical formulation of the following general chemical structure:

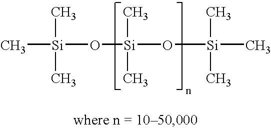

The number of repeating siloxane units (n) in the polymer chain will determine the molecular weight and viscosity of the silicone oil. As the number of siloxane units increases, the polymer becomes longer and both the molecular weight and viscosity increases. Generally, the usable viscosity range of silicone oils is about 5-100,000 centistokes.

While the lubricant can be applied in a non-diluted form, it is often advantageous to dilute the lubricant prior to application to avoid retention of excess lubricant on the surface. For example, the lubricant can be applied to a syringe barrel by filling the barrel with the lubricant, then draining the excess lubricant from the barrel. Depending on the viscosity of the lubricant, an excessive amount of lubricant may remain in the barrel, or the time to drain the barrel may be excessive. By first diluting the lubricant, the viscosity can be controlled such that excess lubricant does not remain on the surface. Alternatively, the lubricant can be applied as a water dispersion or as an emulsion. Any suitable solvent can be used as the diluent that is compatible with the lubricant or combination of lubricants used. By way of example, a perfluorinated solvent can be used with a perfluoropolyether lubricant. The resulting mixture of one or more lubricants and one or more solvents is known as a lubricant-solvent solution. The dilution ratio, or weight percent of lubricant in the lubricant-solvent solution, will vary and depends on a number of factors including the geometry of the surface being coated, viscosity of the non-diluted lubricant, and time between coating the surface and exposing the coated surface to the energy source. The weight percent of lubricant in the solvent, when a solvent is used, may be greater than or equal to about 0.1 percent, such as, for example, 1, 10, 20, 30, 40 and 50. The weight percent of the lubricant in the solvent may also be less than or equal to about 95 percent, such as, for example, 90, 80, 70, and 60. The diluent solvent is evaporated prior to exposure to the energy source.

For commercialization purposes when a lubricant-solvent solution is used, it may be advantageous to heat the surface after applying the lubricant-solvent solution but before exposing the coated surface to the energy source. The purpose of this step is to facilitate the evaporation of the solvent. When articles are mass-produced according to the methods of the present invention, it may be necessary to minimize the time between application of the lubricant-solvent mixture and exposing the coated surface to the energy source. Therefore, the heating step will cause the solvent to evaporate quicker than at ambient conditions. While the solvent can be evaporated at ambient conditions, elevated temperatures up to about 150° C. can be used. Depending on the surface material, the heating step generally can be carried out at any convenient temperature between ambient and about 150° C., generally in the range of about 80° C. to about 130° C. The amount of time that the coated surface is heated depends on a number of factors including, by way of example, the viscosity and vapor pressure of the solvent, the thickness of the lubricant-solvent solution layer applied to the surface, and the geometric configuration of the surface. The amount of time the coated surface is heated may be greater than or equal to about 0.5 minute, such as, for example, 1, 5, 10, and 20 minutes. The amount of time the coated surface is heated may also be less than about 60 minutes, such as, for example, about 50, 40, and 30 minutes.

In addition to being diluted prior to application, the lubricant may also include additives. The additives include, for example, free radical initiators such as peroxides and azo nitriles; viscosity modifiers such as fluoroelastomers, silica, and Teflon® particles; surfactants or wetting agents; anticorrosion agents; antioxidants; antiwear agents; buffering agents; and dyes.

In one embodiment of the invention of the co-pending application, the energy source is an ionizing gas plasma. The gas may be a noble gas including, for example, helium, neon, argon, and krypton. Alternatively, the gas may be an oxidiative gas including, for example, air, oxygen, carbon dioxide, carbon monoxide, and water vapor. In yet another alternative, the gas may be a non-oxidative gas including, for example, nitrogen and hydrogen. Mixtures of any of these gases may also be used.

In another embodiment of the invention of the co-pending application, the lubricant-coated surface is exposed to ionizing radiation which provides the energy necessary to treat the lubricant. The ionizing radiation source can be gamma radiation or electron-beam radiation. Typically, commercial gamma irradiation processing systems use cobalt-60 as the gamma radiation source, although cesium-137 or other gamma radiation source may also be used. Commercial electron-beam radiation systems generate electrons from an electricity source using an electron gun assembly, accelerate the electrons, then focus the electrons into a beam. This beam of electrons is then directed at the material to be treated. The lubricant-coated surface may be exposed to an ionizing radiation dosage ranging from about 0.1 megarad to about 20 megarads, in addition ranging from about 0.5 megarad to about 15 megarads, and further in addition ranging from about 1 megarad to about 10 megarads.

TABLE 1
CHEMICAL STRUCTURE OF EXAMPLE
PERFLUOROPOLYETHER (PFPE) COMPOUNDS

| PFPE Compound | Chemical Structure |
|---|---|
| Fomblin M ® and Fomblin Z ® | CF₃[(—O—CF₂CF₂)p—(O—CF₂)q]—O—CF₃ |
| (Solvay Solexis) | (p + q = 40 to 180; p/q = 0.5 to 2) |
| Fomblin Y ®(Solvay Solexis) | 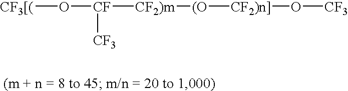 |
| Krytox ®(E. I. du Pont De Nemours and Company) | 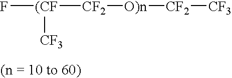 |
| Demnum ™ | F—(CF₂—CF₂—CF₂—O)n—CF₂—CF₃ |
| (Daikin Industries, Limited) | (n = 5 to 200) |

TABLE 2
MOLECULAR WEIGHT AND VISCOSITY OF EXAMPLE
PERFLUOROPOLYETHER (PFPE) COMPOUNDS

| | Molecular Weight | |
|---|---|---|
| | (atomic | Viscosity |
| PFPE Compound | mass units) | (centistokes, 20° C.) |
| Fomblin M ® and Fomblin Z ® | 2,000–20,000 | 10–2,000 |
| (Solvay Solexis) | | |
| Fomblin Y ® | 1,000–10,000 | 10–2,500 |
| (Solvay Solexis) | | |
| Krytox ® | 500–12,000 | 7–2,000 |
| (E.I. du Pont de Nemours and | | |
| Company) | | |
| Demnum ™ | 1,000–20,000 | 10–2,000 |
| (Daikin Industries, Limited) | | |
| Daifloil ™ | 500–1,100 | 5–1,500^{a} |
| (Daikin Industries, Limited) | | |

^{a}Viscosity at 25° C.

TABLE 3
FUNCTIONAL GROUPS, MOLECULAR WEIGHT, AND VISCOSITY OF
FUNCTIONALIZED PERFLUOROPOLYETHER (PFPE) COMPOUNDS

| | | Number of | | |
|---|---|---|---|---|
| | | Functional | | Viscosity |
| Functionalized | | Groups per | Molecular Weight | (centistokes, |
| PFPE Compound | Functional Group | Molecule | (atomic mass units) | 20° C.) |
| Fomblin ZDOL ® | Alcohol | 1–2 | 1,000–4,000 | 50–150 |
| Fluorolink D ® | —CH₂(OH) | | | |
| (Solvay Solexis) | | | | |
| Fomblin ZDOL | Alcohol | 1–2 | 1,000–2,500 | 80–150 |
| TXS ® | | | | |
| Fluorolink E ® | —CH₂(OCH₂CH₂)nOH | | | |
| Fluorolink E10 ® | | | | |
| (Solvay Solexis) | | | | |
| Fluorolink T ® | Alcohol | 2–4 | 1,000–3,000 | 2,000–3,000 |
| Fluorolink T10 ® | —CH₂OCH₂CH(OH)CH₂OH | | | |
| (Solvay Solexis) | | | | |
| Fomblin ZDIAC ® | Alkly Amide | 1–2 | 1,800 | Wax |
| Fluorolink C ® | —CONHC₁₈H₃₇ | | | |
| (Solvay Solexis) | | | | |
| Fluorolink L ® | Ester | 1–2 | 1,000–2,000 | 10–25 |
| Fluorolink L10 ® | —COOR | | | |
| (Solvay Solexis) | | | | |
| Fluorolink S10 ® | Silane | 1–2 | 1,750–1,950 | 170 |
| (Solvay Solexis) | | | | |
| Fluorolink F10 ® | Phosphate | 1–2 | 2,400–3,100 | 18,000 |
| (Solvay Solexis) | | | | |

### EXAMPLE 1

Glass Syringes—No Plasma Pretreatment

Ten short glass syringe barrels (size 1 ml) were sprayed with 0.3 micro liters of perfluoropolyether lubricant (Fomblin M100® from Solvay Solexis) on the inside surfaces of the syringe barrel. These syringe barrels were then plasma treated at atmospheric pressure using helium carrier gas but without any reactive gas for 0.5 seconds. The syringes were assembled using clean halobutyl rubber stoppers.

Five syringes from this set were assembled empty, with no fluid in them, and the other five syringes were filled with DI water. The syringe stoppers from each set were parked in one position in the barrel, and they were then stored in an oven at 60° C. for 72 hours. The syringes were removed from the oven and then allowed to condition at ambient conditions for 5 hours. After conditioning, the syringe forces were measured using a Harvard Apparatus syringe pump mounted with a Dillon AFG-100N digital force gauge at a rate of 2 ml/min.

### EXAMPLE 2

Glass Syringes—with Ethylene Plasma Pretreatment

Ten short glass syringes (size 1 ml) were first plasma treated at atmospheric pressure using the following pre-treatment conditions:

Reactive gas—ethylene (flow rate—2.4 standard cc/min)

Carrier gas—helium (flow rate—2 standard liters/min)

Atmospheric plasma treatment—5 seconds

To check the effectiveness of the plasma pretreatment, the inner surface of the syringes were tested for wetting with DI water. Before the pretreatment, the water contact angle was approximately 5 degrees indicating complete wetting of the surface. Following the plasma pretreatment, the contact angle was greater than 50 degrees indicating a hydrophobic surface.

Following pretreatment, the glass syringe barrels were sprayed with 0.3 micro liters of perfluoropolyether lubricant (Fomblin M100® from Solvay Solexis) on the inside surfaces of the syringe barrel. The sprayed syringe barrels were plasma treated at atmospheric pressure using helium gas for 0.5 seconds. The syringes were assembled using clean halobutyl rubber stoppers.

Five syringes from this set were assembled empty with no fluid in them, and the remaining five syringes were filled with DI water. The syringe stoppers from each set were parked in one position in the barrel, and they were then stored in an oven at 60° C. for 72 hours. The syringes were removed from the oven and then allowed to condition at ambient conditions for 5 hours. After conditioning, the syringe forces were measured using a Harvard Apparatus syringe pump mounted with a Dillon AFG-100N digital force gauge at a rate of 2 ml/min.

### Discussion of Results for Examples 1 and 2

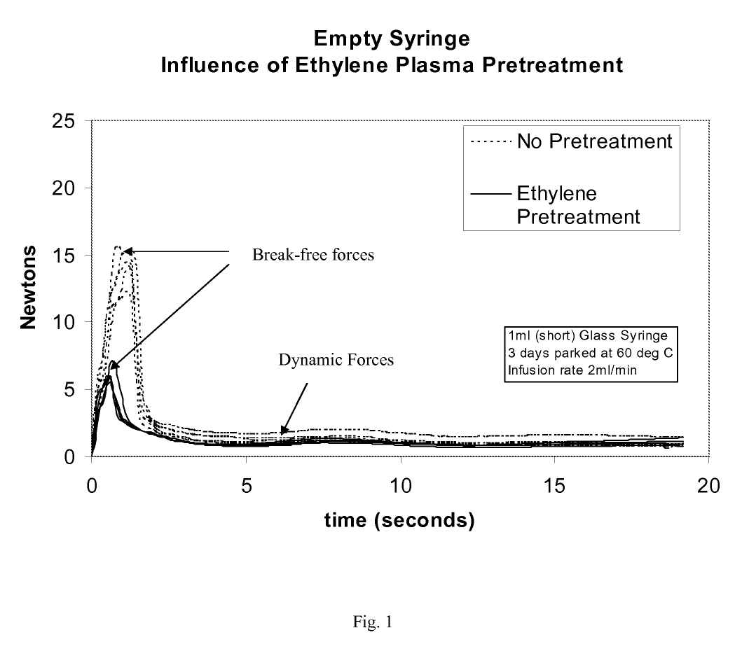

FIG. 1 demonstrates the syringe forces for empty syringes. One set contained syringes without any plasma pretreatment (Example 1) and the second set demonstrated forces for syringes processed with the ethylene plasma pretreatment (Example 2). The syringes were assembled “empty” without any fluid in the syringe barrels.

Results:

1. Break-free force—Ethylene pretreated syringes measures 60 percent lower force than the non-pretreated

2. Dynamic force—Both sets of syringes demonstrated comparable dynamic syringe forces.

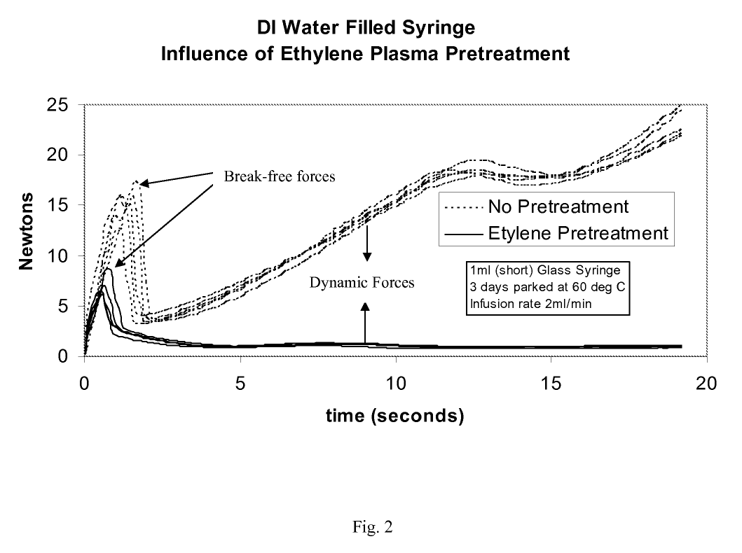

FIG. 2 demonstrates the syringe forces for DI water filled syringes. One set contains syringes without any plasma pretreatment (Example 1), and the second set demonstrates forces for syringes processed with the ethylene plasma pretreatment (Example 2).

Results:

1. Break-free force—Ethylene pretreated syringes measured 60 percent lower force than the untreated syringes.

2. Dynamic force—Without pretreatment, the dynamic forces increased rapidly to unacceptably high levels. Ethylene pretreated samples demonstrate low and consistent dynamic force which are comparable to empty syringes as depicted in FIG. 1.

### CONCLUSIONS

Ethylene plasma pretreatment resulted in a 60 percent drop in break-free force over untreated syringes when tested empty, as well as DI water filled syringes. This indicated that the squeezing action resulting from the compressive forces exerted by the parked stopper did not completely displace the lubricant in the case of the ethylene pretreated syringe barrel, which indicated better bonding between the lubricant and the pretreated surface.

For DI water filled syringes, the dynamic forces in the case of syringes without pretreatment rose rapidly to unacceptably high levels, greater than the initial break-free forces. This indicated that the water had displaced the lubricant, and the forces increased as the stopper traveled down the syringe barrel. In the case of the ethylene plasma pretreated syringes, the dynamic forces are consistently low, which indicated that no displacement of the lubricant was induced by the fluid medium.

These results clearly show an unexpected but extremely important performance enhancement, particularly for glass syringes that are prefilled with a medicant (fluid) and are stored for an extended period of time before use.

I claim:

1. A method for treating a surface of an article in order to increase the hydrophobic characteristics of the surface, comprising:
(a) providing one or more surfaces; and
(b) exposing the surface to an ionizing gas plasma at about atmospheric pressure for a predetermined period of time, the ionizing gas plasma being formed from a gas mixture comprising a carrier gas and a reactive gas.

2. The method of claim 1 wherein the article is a glass article.

3. The method of claim 1 wherein the carrier gas is selected from one or more groups comprising helium, neon, argon, krypton, xenon, air, oxygen, carbon dioxide, carbon monoxide, water vapor, nitrogen, hydrogen, and mixtures thereof.

4. The method of claim 1 wherein the reactive gas is hydrocarbon compound.

5. The method of claim 4 wherein the reactive gas is selected from one or more groups comprising an alkane, an alkene, and an alkyne, and mixtures thereof.

6. The method of claim 5 wherein the reactive alkane gas is selected from one or more groups comprising methane, ethane, propane, butane, and mixtures thereof.

7. The method of claim 5 wherein the reactive alkene gas is selected from one or more groups comprising ethylene, propylene, isobutylene, and mixtures thereof.

8. The method of claim 5 wherein the reactive alkyne gas is selected from one or more groups comprising ethyne, propyne, 1-butyne, and mixtures thereof.

9. The method of claim 1 wherein the reactive gas is a fluorocarbon compound.

10. The method of claim 9 wherein the fluorocarbon reactive gas is selected from one or more groups comprising tetrafluoromethane, tetrafluoroethylene, hexafluorppropylene, and mixtures thereof.

11. The method of claim 1 wherein the concentration of the reactive gas ranges from about 0.001 percent to about 10 percent, and the remainder of the gas mixture is made up of the carrier gas.

12. The method of claim 1 wherein the predetermined period of time for exposing the surface to the ionizing gas plasma ranges from about 0.1 second to about 5 minutes.

13. A method for preparing a glass surface in order to increase bonding between the glass surface and a subsequently applied lubricant, comprising exposing the surface to an ionizing gas plasma at about atmospheric pressure for a period of time ranging from about 0.1 second to about 30 seconds, the ionizing gas plasma being formed from a mixture of an inert carrier gas and a reactive gas.

14. The method of claim 13 wherein the carrier gas is selected from one or more groups comprising helium, neon, argon, krypton, xenon, air, oxygen, carbon dioxide, carbon monoxide, water vapor, nitrogen, hydrogen, and mixtures thereof.

15. The method of claim 13 wherein the reactive gas is a hydrocarbon compound.

16. The method of claim 15 wherein the reactive gas is selected from one or more groups comprising an alkane, an alkene, an alkyne, and mixtures thereof.

17. The method of claim 16 wherein the reactive alkane gas is selected from one or more groups comprising methane, ethane, propane, butane, and mixtures thereof.

18. The method of claim 16 wherein the reactive alkene gas is selected from one or more groups comprising ethylene, propylene, isobutylene, and mixtures thereof.

19. The method of claim 16 wherein the reactive alkyne gas is selected from one or more groups comprising ethyne, propyne, 1-butyne, and mixtures thereof.

20. The method of claim 13 wherein the reactive gas is a fluorocarbon compound.

21. The method of claim 20 wherein the fluorocarbon reactive gas is selected from one or more groups comprising tetrafluoromethane, tetrafluoroethylene, hexafluoropropylene, and mixtures thereof.

22. The method of claim 13 wherein the concentration of the reactive gas ranges from about 0.001 percent to about 10 percent, and the remainder of the gas mixture is made up of the carrier gas.

23. A method for increasing the hydrophobic characteristics of a glass surface, comprising exposing the surface to an ionizing gas plasma at about atmospheric pressure for a period of time ranging from about 0.1 second to about 30 seconds, the ionizing gas plasma being formed from a mixture of ethylene and an inert carrier gas, wherein the concentration of ethylene in the mixture ranges from about 0.001 percent to about 1 percent.

24. A method for preparing a glass surface in order to increase bonding between the glass surface and a subsequently applied lubricant, comprising exposing the surface to an ionizing gas plasma at about atmospheric pressure for a period of time ranging from about 0.1 second to about 30 seconds, the ionizing gas plasma being formed from a mixture of ethylene and an inert carrier gas, wherein the concentration of ethylene in the mixture ranges from about 0.001 percent to about 1 percent.
